(19) United States
(12) Patent Application Publication
(10) Pub. No.: US 2017/0032253 A1
(43) Pub. Date: Feb. 2, 2017

(54) INFORMATION PROCESSING APPARATUS, CONTROL METHOD, AND PROGRAM

(71) Applicant: SONY CORPORATION, TOKYO (JP)

(72) Inventor: MUNECHIKA MAEKAWA, KANAGAWA (JP)

(21) Appl. No.: 15/302,226

(22) PCT Filed: Jan. 28, 2015
(86) PCT No.: PCT/JP2015/052319

§ 371 Date: Oct. 6, 2016

(30) Foreign Application Priority Data
Apr. 25, 2014 (JP) 2014-091803

(51) Int. Cl. G06N 5/02; G06F 17/30

(52) U.S. Cl. CPC G06N 5/022; G06F 17/30979

(57) ABSTRACT

Proposed is an information processing apparatus, control method, and program capable of presenting an answering entity candidate to the user in order to achieve optimum request assignment. The information processing apparatus includes: a selection unit configured to check each element included in a context of a user request against an answering entity profile, and select an answering entity candidate capable of answering the context of the user request; and a presentation unit configured to present the answering entity candidate selected by the selection unit to a user who has issued the request.

### CROSS REFERENCE TO RELATED APPLICATIONS

This application is a U.S. National Phase of International Patent Application No. PCT/JP2015/052319 filed on Jan. 28, 2015, which claims priority benefit of Japanese Patent Application No. JP 2014-091803 filed in the Japan Patent Office on Apr. 25, 2014. Each of the above-referenced applications is hereby incorporated herein by reference in its entirety.

### TECHNICAL FIELD

The present invention relates to information processing apparatuses, control methods, and programs.

### BACKGROUND ART

Many people have in recent years used information terminals, computers, and the like due to the development of the information industry. Under these circumstances, concierge services based on human resources have been proposed to answer and respond to questions and requests from a variety of people. Also, server knowledge-based and community-driven “question-and-answer” services using a database on a network have been proposed. Also, fully-automated support services have been proposed.

For example, Patent Literature 1 below discloses an inquiry handling apparatus capable of quickly and appropriately handling inquiries, which receives an inquiry from a user, and handles the inquiry, taking into account the level of a priority given to the user.

### CITATION LIST

### Patent Literature

Patent Literature 1: JP 2001-134657A

### SUMMARY OF INVENTION

### Technical Problem

Although the above concierge services based on human resources have the advantage of being capable of supporting special tasks in the respective fields of specialists, these services cannot handle a task outside their fields, and have limited business hours. Also, in the knowledge-based and community-driven “question-and-answer” services, more and more questions and answers are accumulated in a database on a network, and there is the advantage of being capable of questioning and answering without a constraint on time, i.e., at any time, however the response may be slow, and similar questions and answers may be redundantly accumulated. In addition, in the fully-automated support services, there is not a constraint on time and the response is quick, however there is little useful information.

Thus, each of the above services has its own advantages and disadvantages. Therefore, if each service can be automatically assigned an optimum request according to the content of the request, the services can be more effectively utilized.

With the above in mind, the present disclosure proposes an information processing apparatus, control method, and program capable of presenting an answering entity candidate to the user in order to achieve optimum request assignment.

### Solution to Problem

According to the present disclosure, there is provided an information processing apparatus including: a selection unit configured to check each element included in a context of a user request against an answering entity profile, and select an answering entity candidate capable of answering the context of the user request; and a presentation unit configured to present the answering entity candidate selected by the selection unit to a user who has issued the request.

According to the present disclosure, there is provided a control method including: checking each element included in a context of a user request against an answering entity profile, and selecting an answering entity candidate capable of answering the context of the user request; and presenting the selected answering entity candidate to a user who has issued the request.

According to the present disclosure, there is provided a program for causing a computer to function as: a selection unit configured to check each element included in a context of a user request against an answering entity profile, and select an answering entity candidate capable of answering the context of the user request; and a presentation unit configured to present the answering entity candidate selected by the selection unit to a user who has issued the request.

### Advantageous Effects of Invention

As described above, according to the present disclosure, it is possible to present an answering entity candidate to the user in order to achieve optimum request assignment.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram for describing an overview of an automatic request assignment system according to one embodiment of the present disclosure.

FIG. 2 is a block diagram showing a configuration example of a server which achieves automatic request assignment according to this embodiment.

FIG. 3 is a sequence diagram of a process of analyzing a request and selecting an answering entity candidate according to this embodiment.

FIG. 4 is a diagram for describing extraction of an assumed request from a user profile tree (virtual personality user model).

FIG. 5 is a diagram showing an example of hashing of a request.

FIG. 6 is a diagram showing an example of the structure of a request hash.

FIG. 7 is a diagram for describing a process of searching a track record DB and a process of searching an answering entity DB.

FIG. 8 is a sequence diagram of an answering process according to this embodiment.

FIG. 9 is a diagram showing a screen example displaying answering entity candidates.

FIG. 10 is a diagram showing a result display example where an answer is provided in a text-based manner.

FIG. 11 is a diagram showing a result display example where an answer is provided in a map-based manner.

FIG. 12 is a sequence diagram of a feedback process according to this embodiment.

FIG. 13 is a diagram showing an example of revision of the rating of an answering entity profile.

FIG. 14 is a diagram for describing a first application example.

FIG. 15 is a diagram for describing a second application example.

FIG. 16 is a diagram for describing a third application example.

### DESCRIPTION OF EMBODIMENT(S)

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Also, description will be provided in the following order.

1. Overview of automatic request assignment system according to one embodiment of the present disclosure

2. Basic configuration

3. Operating process

3-1. Request assignment process

3-2. Answering process

3-3. Feedback process

4. Application examples

5. Conclusion

### 1. OVERVIEW OF AUTOMATIC REQUEST ASSIGNMENT SYSTEM ACCORDING TO ONE EMBODIMENT OF THE PRESENT DISCLOSURE

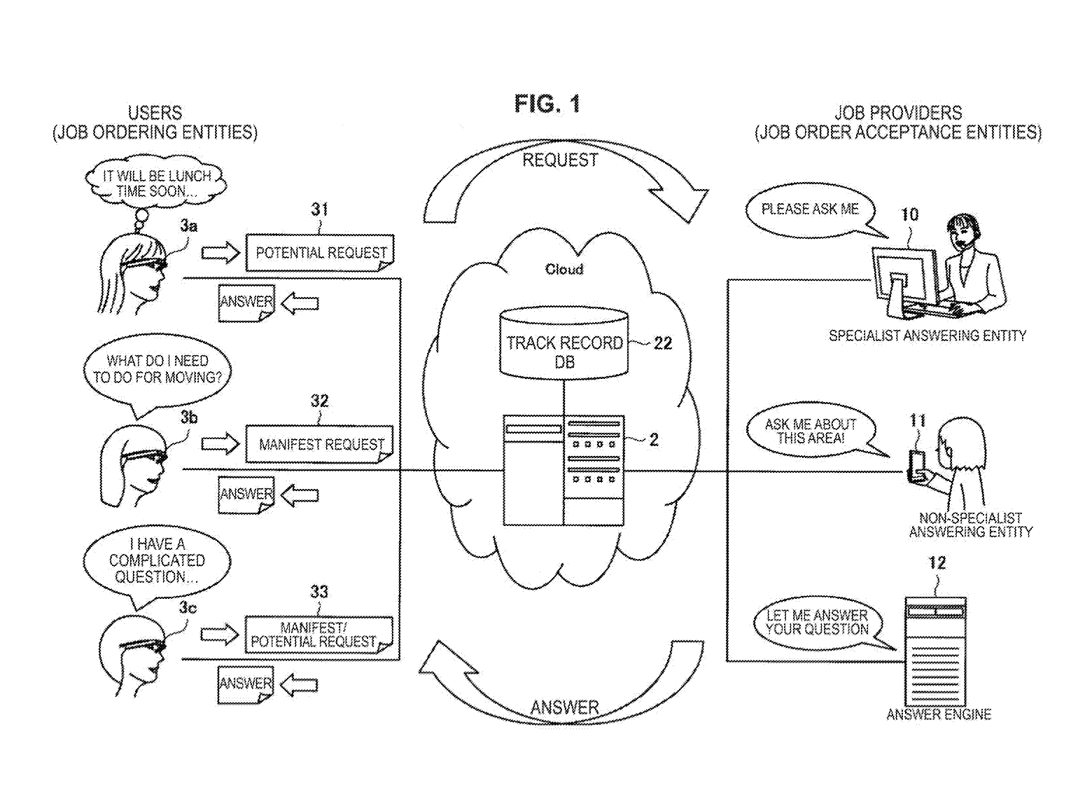

Firstly, an overview of an automatic request assignment system according to one embodiment of the present disclosure will be described with reference to FIG. 1. As shown in FIG. 1, the automatic request assignment system according to this embodiment includes user terminals 3 (user terminals 3a, 3b, and 3c) possessed by users who send a request (job ordering entities), a server 2, and apparatuses (answering entity terminals 10 and 11 and an answer engine 12) possessed by job providers (job order acceptance entities) which respond to requests.

In such a system configuration, the server 2 automatically assigns contexts (user demands abstracted from requests) of requests transmitted from the user terminals 3 to optimum job providers. Specifically, the server 2 checks each element contained in a request context with an answering entity profile which is information about each job provider, to select an answering entity candidate which can respond to the request, and present the answering entity candidate to a user. Thereafter, the server 2 sends the request to the answering entity candidate decided by a user, and presents an obtained answer to the user. Specifically, for example, the server 2 sends a request to an answering entity candidate decided by a user, and thereafter, performs a process of connecting the user with the answering entity so that an answer from the answering entity is presented directly to the user.

Note that requests transmitted from the user terminals 3 include a potential request 31 which is guessed on the basis of the result of detection of user conditions (request produced from a potential request found by sensing), a manifest request 32 based on an explicit input entered by a user (normal request), and a manifest/potential request 33 based on an explicit input and a guess (complicated request).

Also, examples of the job providers include a support service provided by a specialist answering entity, a support service provided by a non-specialist answering entity, and a support service provided by a fully-automated answer engine.

There is not a particular limit on which answering entity (the specialist answering entity, the non-specialist answering entity, or the answer engine) is assigned to which request (the potential request 31, the manifest request 32, or the manifest/potential request 33). The assignment is optimized by the server 2 according to the content of a request (the context of a request) or the situation (whether or not an immediate response is essential).

The server 2 further has a track record database (DB) 22. When one similar to a request transmitted from a user has already been answered, this past answer may be presented to the user.

In the foregoing, an overview of the automatic request assignment system according to one embodiment of the present disclosure has been described. Thus, in this embodiment, an answering entity candidate can be presented to a user for optimum request assignment. Although, in the example shown in FIG. 1, a glasses-type head mounted display (HMD) has been shown as an example of the user terminals 3, the user terminals 3 are not limited to this. The user terminals 3 may, for example, be a smartphone, tablet terminal, mobile telephone terminal, camera, game machine, music player, or the like.

### 2. BASIC CONFIGURATION

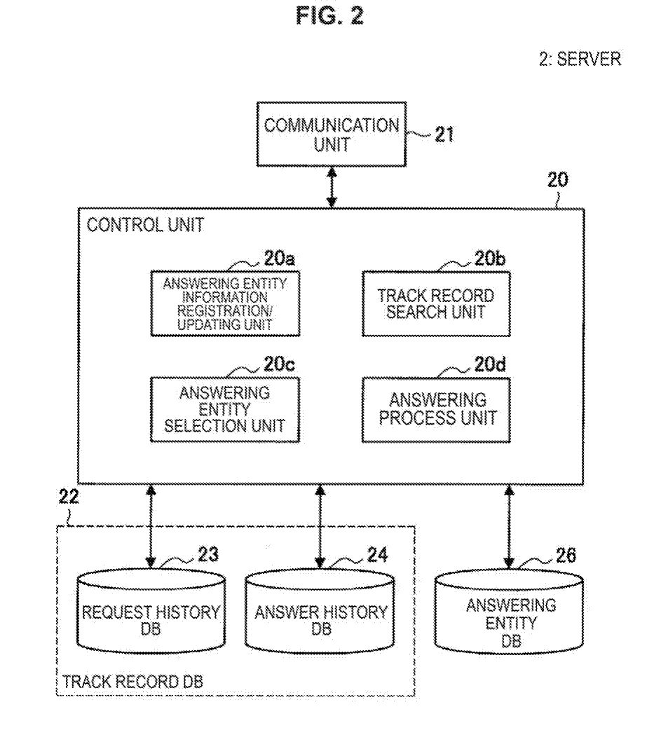

Next, a configuration example of the server 2 according to this embodiment which achieves automatic request assignment will be described with reference to FIG. 2. As shown in FIG. 2, the server 2 has a control unit 20, a communication unit 21, a request history DB 23, an answer history DB 24, and an answering entity DB 26.

### (Control Unit)

The control unit 20 includes, for example, a microcomputer equipped with a central processing unit (CPU), a read only memory (ROM), a random access memory (RAM), a non-volatile memory, and an interface unit. The control unit 20 controls each component of the server 2.

Also, as shown in FIG. 2, the control unit 20 according to this embodiment functions as an answering entity information registration/updating unit 20a, a track record search unit 20b, an answering entity selection unit 20c, and an answering process unit 20d.

The answering entity information registration/updating unit 20a performs a process of registering or updating information about each answering entity in a job provider (answering entity profile) into the answering entity DB 26. Also, the answering entity information registration/updating unit 20a incorporates evaluations of answering entities or the contents of answers which have been done by users into the answering entity DB 26.

The track record search unit 20b searches the track record DB 22 for an answer to a request. As a result, it is possible to respond immediately using a past similar answer. Note that, as shown in FIG. 2, the track record DB 22 includes the request history DB 23 and the answer history DB 24.

The answering entity selection unit 20c selects an answering entity which can provide an answer, from a job provider, according to the context of a request. At this time, the answering entity selection unit 20c may select a plurality of answering entities as answering entity candidates.

Each job provider includes, for example, a support service provided by a specialist answering entity, a support service provided by a non-specialist answering entity, and a support service provided by a fully-automated answer engine. Support by a specialist answering entity is, for example, most suitable for a request strongly related to business, a request related to special knowledge/skill, or the like. Support by a specialist answering entity may need to be paid for. Also, support by a non-specialist answering entity is, for example, most suitable for a request which cannot be supported by a specialist answering entity, a request on which a user cannot spend any expense, and the like. Also, support by a fully-automated answer engine is most suitable for a case where the content of a request can be answered by the answer engine.

The answering process unit 20d transmits the context of a request and makes an inquiry with respect to an answering entity which has been selected by a user from answering entity candidates presented to the user, presents an answer from the answering entity to the user, and performs a process of connecting the user to the answering entity. Also, the answering process unit 20d may automatically select a suitable answering entity from a plurality of answering entity candidates which have been selected by the answering entity selection unit 20c, and make an inquiry with respect to the selected answering entity.

### (Communication Unit)

The communication unit 21 transmits and receives data to and from an external apparatus connected to a network. For example, the communication unit 21 receives requests from the user terminals 3, and transmits a plurality of answering entity candidates selected by the answering entity selection unit 20c, or past answers searched for by the track record search unit 20b, to the user terminals 3, which then output the received information. Also, the communication unit 21 transmits the context of a request and thereby makes an inquiry with respect to a provider.

### (Request History DB)

The request history DB 23 is a database which accumulates past requests.

### (Answer History DB)

The answer history DB 24 is a database which accumulates past answers.

### (Answering Entity DB)

The answering entity DB 26 is a database which stores information about each answering entity in a job provider (answering entity profile). Data registration and updating with respect to the answering entity DB 26 are performed by the answering entity information registration/updating unit 20a.

### 3. OPERATING PROCESS

Next, an operating process of automatic request assignment according to this embodiment will be described.

### 3-1. Request Assignment Process

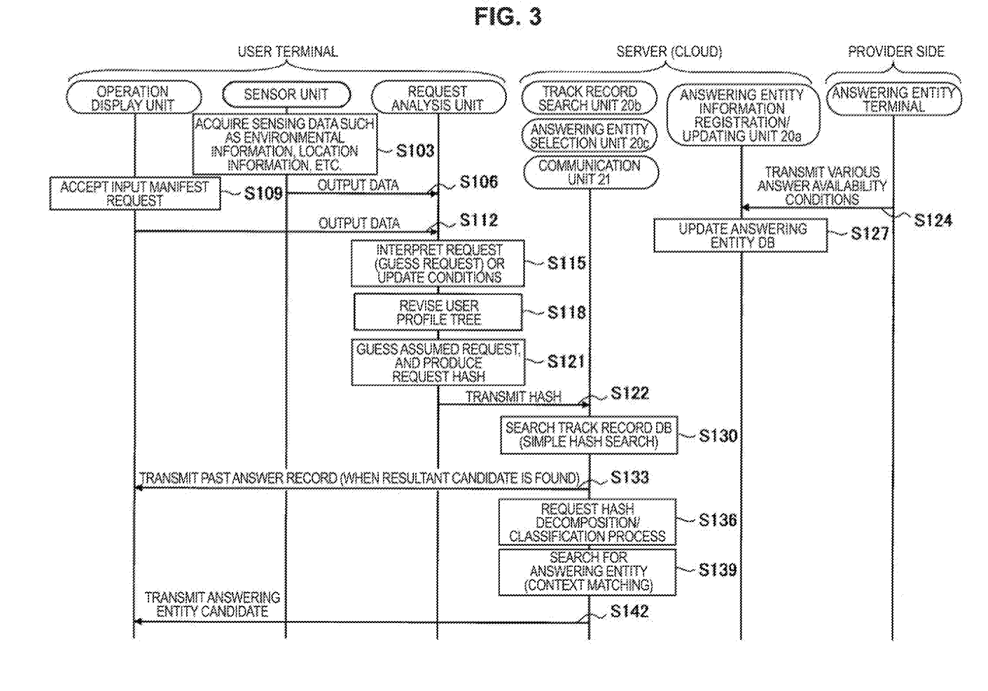

FIG. 3 is a sequence diagram of a request analysis process and an answering entity candidate selection process according to this embodiment. As shown in FIG. 3, initially, in step S103, a user terminal 3 senses user conditions (sensing data) using a sensor unit. Specifically, the sensor unit acquires conditions of the user and surroundings, such as environmental information (ambient temperature, humidity, etc.), location information, biological information (brain waves, a pulse, perspiration, etc.), information about network access, information about transmission of a mail, blog, etc., a log of actions, and the like, using various sensors. The acquired sensing data is output to a request analysis unit (S106). The sensing data is used to produce a request from a potential desire.

Next, in step S109, the user terminal 3 receives a manifest request input from an operation display unit. Specifically, the operation display unit, which is, for example, implemented by a touch panel display, recognizes an explicit request input by the user, such as text or a touch operation. Also, the user terminal 3 can also analyze the user's voice using a voice input unit to recognize an explicit request. The acquired input data is output to the request analysis unit (S112). The input data is handled as a manifest desire (normal manifest request).

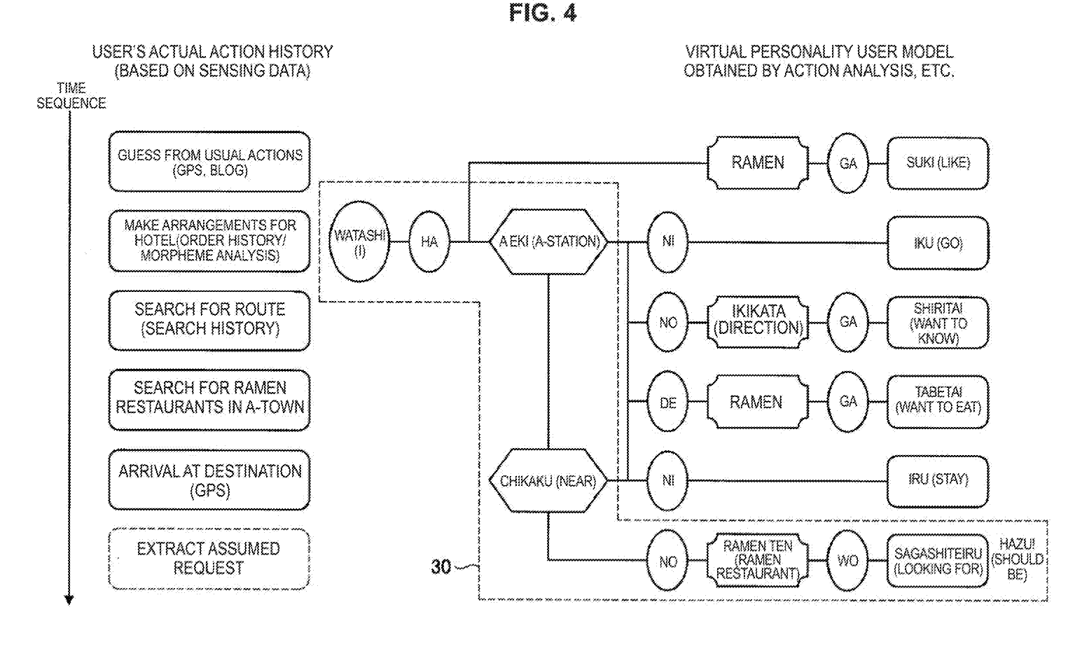

Next, in step S115, the user terminal 3 interprets the request on the basis of at least either of the sensing data acquired by sensing or the input data using a request analysis unit (context production unit) to guess what is intended by the request, i.e., produce a context. For example, the user terminal 3 produces a request from a potential desire on the basis of the sensing data acquired by sensing, interprets a manifest request on the basis of the input data input explicitly, or interprets a potential/manifest request (complicated request) on the basis of the sensing data acquired by sensing and the input data input explicitly. Also, the request analysis unit updates user conditions (“user's actual action history” shown in FIG. 4) on the basis of the sensing data.

Next, in step S118, the request analysis unit revises (updates) a user profile tree. The user profile tree is a virtual personality user model which is obtained from, for example, the result of analysis of an action history which is a history of a user's actual actions continually acquired on the basis of sensing data. In this embodiment, the above steps S103 to S118 are automatically repeated so that the user profile tree which is a virtual personality user model is revised in real time.

Next, in step S121, the request analysis unit guesses an assumed request (produces a context) to produce a request hash. An assumed request is, for example, produced by extracting from the user profile tree. Here, the extraction of an assumed request from the user profile tree (virtual personality user model) will be described with reference to FIG. 4.

FIG. 4 is a diagram for describing the extraction of an assumed request from the user profile tree (virtual personality user model). As shown in FIG. 4, sensing data is sequentially acquired (by the user terminal 3) in a time-series manner so that a history of the user's actual actions is accumulated. At the same time, a virtual personality user model is revised in real time on the basis of the acquired action history. Thereafter, for example, the arrival at a destination triggers extraction of an assumed request from the virtual personality user model. In the example shown in FIG. 4, an assumed request 30 indicating that “Watashi ha A eki chikakuno ramen ten wo sagashiteiru (I am looking for a ramen restaurant near the A-station)” is extracted. As a result, in this embodiment, even if there is not an explicit request input indicating that “A eki no ramen ten wo sagasu (searching for a ramen restaurant at the A-station),” a request can be produced from a potential desire by extracting an assumed request from the virtual personality user model which is revised in real time on the basis of sensing data acquired continually. Although, in this embodiment, the virtual personality user model is generated in order to generate an assumed request (context), this technique is merely illustrative, and this embodiment is not limited to this.

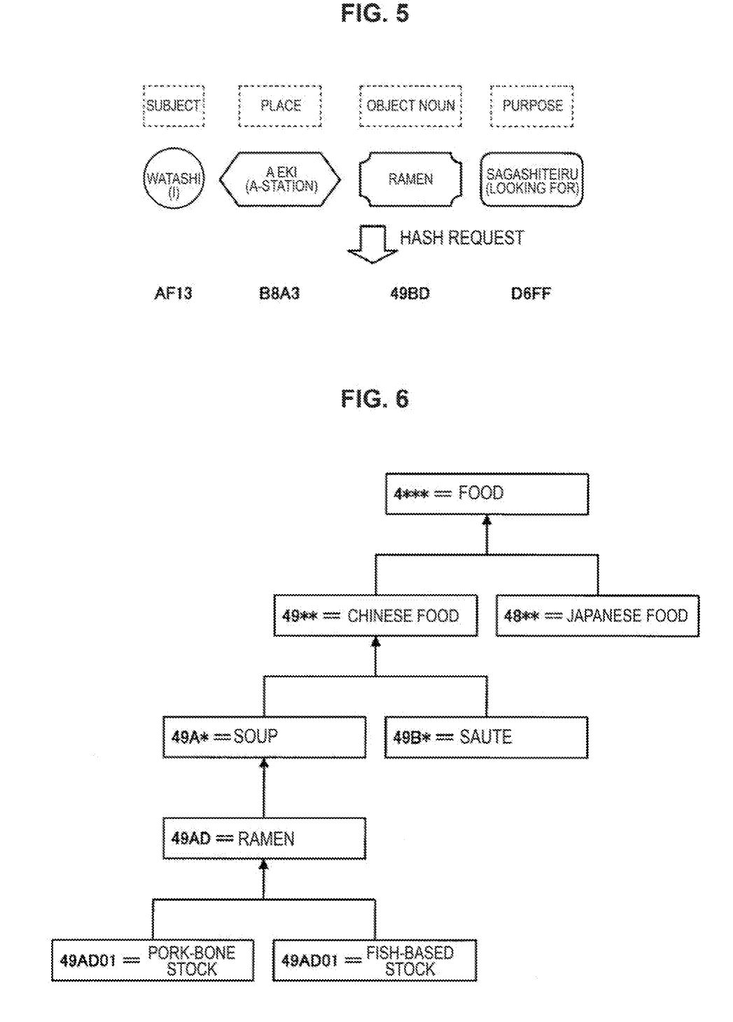

Also, the request analysis unit hashes the extracted assumed request to facilitate search or matching. Here, production of a request hash will be described with reference to FIG. 5.

FIG. 5 is a diagram showing an example of hashing of a request. The words (elements), “Watashi (I),” “A eki (A-station),” “ramen,” and “sagashiteiru (looking for)” contained in the assumed request 30 extracted in the example shown in FIG. 4 are replaced with a hash value like “AF13B8A349BDD6FF” shown in FIG. 5. Thus, in this embodiment, the elements of a request are replaced with a structured hash, and therefore, during search/matching in the server 2, context matching can be achieved even when request contents do not match exactly. Here, an example of the structure of a request hash is shown in FIG. 6. As shown in FIG. 6, a hash value “49AD” corresponding to “ramen” belongs to a hash value “49A*” corresponding to “soup” in terms of the structure. Therefore, when matching is performed between a request context and, for example, an answering entity profile, even if there is not an exact match (the hash value “49AD” is found), a close answering entity profile (the hash value “49A*” is found) can be extracted.

Next, in step S122, the user terminal 3 transmits the request hash (hashed request context) produced by the request analysis unit to the server 2. Thus, in this embodiment, the user terminal 3 analyzes a request and transmits a hashed request context to the server 2. As a result, the user's sensing data or the like is not uploaded to a network, and therefore, the privacy of the user can be protected.

Meanwhile, in step S124, the answering entity terminals 10 to 12 in a provider transmit various answer availability conditions to the server 2. The answer availability conditions include, for example, characteristics, specialty, waiting/response available times, charge conditions, ways of answering (a text base, a map, voice communication), and the like of an answering entity.

Next, in step S127, the answering entity information registration/updating unit 20a of the server 2 registers or updates answer availability conditions transmitted from the answering entity terminals 10 to 12 in the answering entity DB 26.

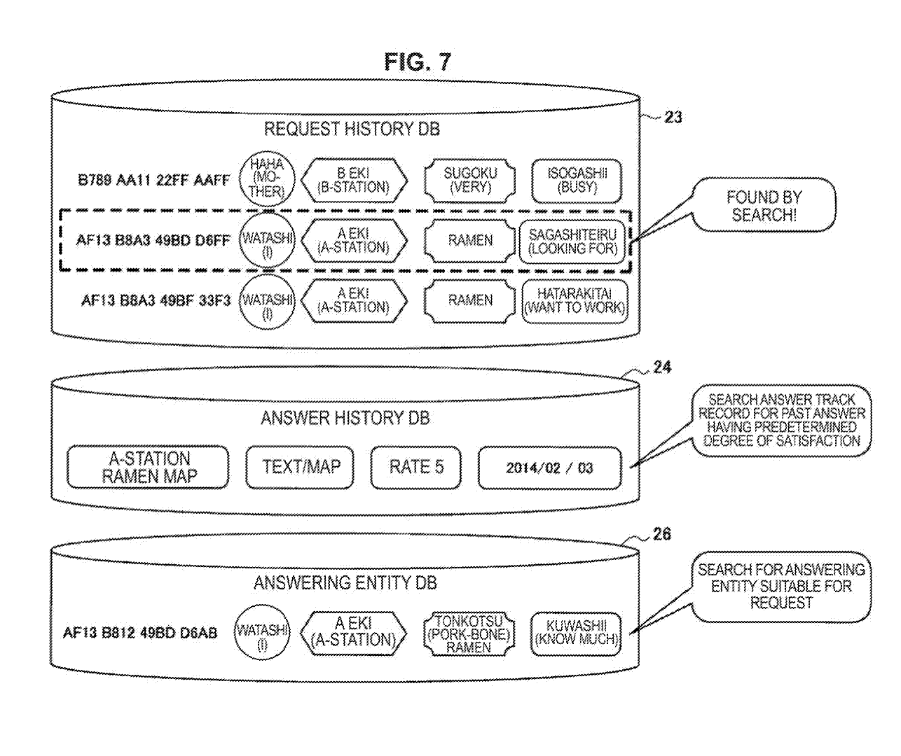

Next, in step S130, the server 2, which has received the hashed request, searches the track record DB 22 (simple hash search) using the track record search unit 20b. As shown in FIG. 2, the track record DB 22 includes the request history DB 23 and the answer history DB 24. The track record search unit 20b searches the request history DB 23 for a past similar request on the basis of the hash value. Here, a process of searching the track record DB 22 and a process of searching the answering entity DB 26 are shown in FIG. 7.

As shown in an upper portion of FIG. 7, the request history DB 23 included in the track record DB 22 is searched on the basis of a hash value (e.g., “AF13B8A349BDD6FF”) to extract a request which exactly matches the hash value (simple hash search). When a request matching the hash value is found, the answer history DB 24 shown in a middle portion of FIG. 7 is searched for an answer corresponding to the found request. When an answer which has a predetermined degree of satisfaction exceeding a threshold is found, the answer is extracted and transmitted to the user terminal 3, and is output from the operation display unit of the user terminal 3 (S133).

Next, when there is not any request that exactly matches in the track record or even when such a request is found in the track record, the answering entity selection unit 20c of the server 2 searches the answering entity DB 26 shown in a lower portion of FIG. 7 for an answering entity suitable for the request (answering entity candidate).

Specifically, in step S136, the answering entity selection unit 20c performs a process of decomposing a request hash into elements and classifying each element. In step S139, the answering entity selection unit 20c searches the answering entity DB 26 for an answering entity suitable for the request (answering entity candidate) (context matching). For example, in an example shown in FIG. 7, in the answering entity DB 26, found is an answering entity associated with a hash value “AF13B81249BDD6AB,” which a portion (“AF13B81249BD”) of the elements obtained by the decomposition matches. Here, an answering entity which is associated with a hash value which does not exactly match and is close (an upper-level hash value in the hash structure) may be searched for.

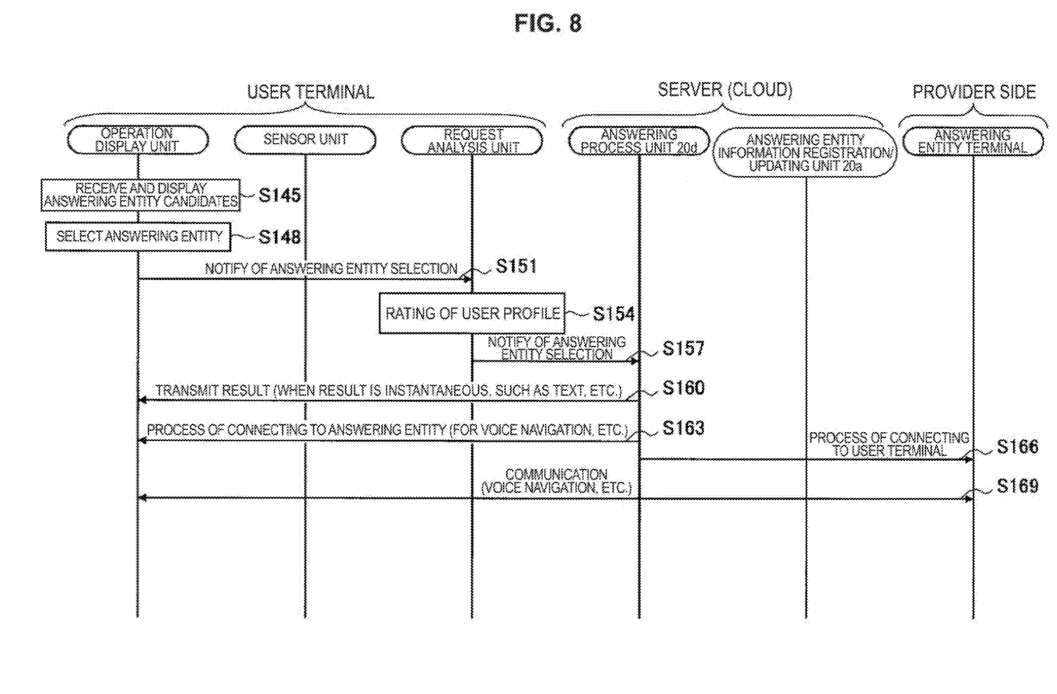

Next, in step S142, the server 2 transmits an answering entity candidate suitable for a request which has been searched for (selected) by the answering entity selection unit 20c, to the user terminal 3 through the communication unit 21. Here, the server 2 may transmit a plurality of answering entity candidates. The answering entity candidate transmitted to the user terminal 3 is displayed and output by the operation display unit. Processes following the displaying and outputting will next be described with reference to FIG. 8.

### 3-2. Answering Process

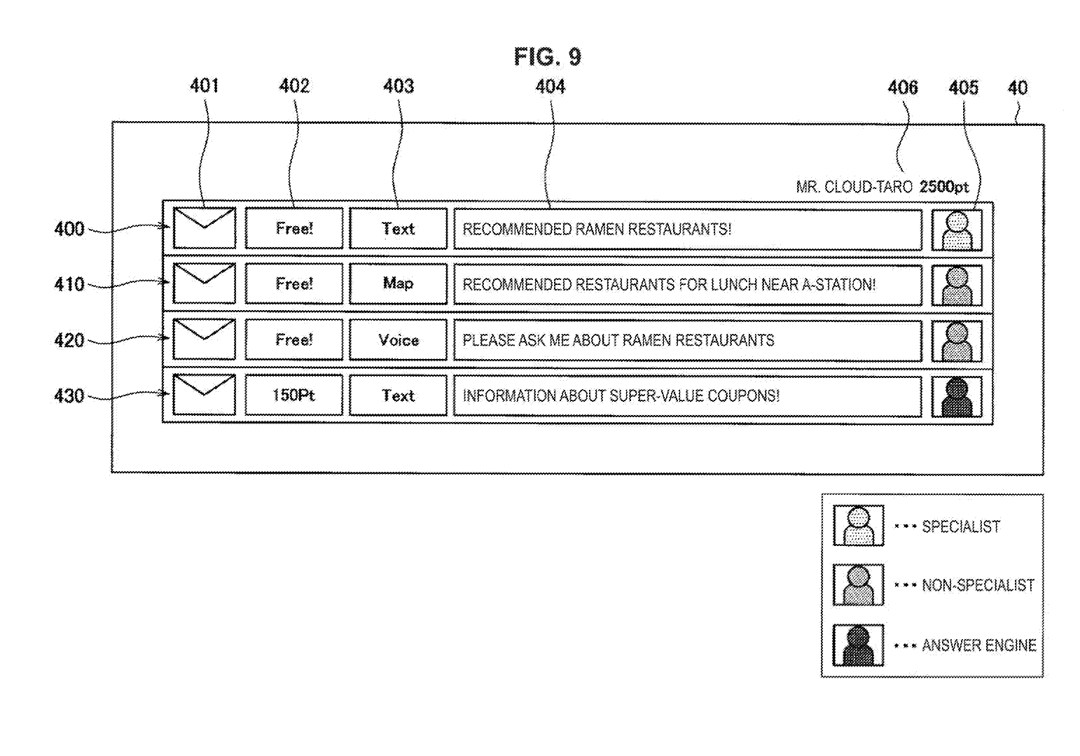

FIG. 8 is a sequence diagram of an answering process according to this embodiment. As shown in FIG. 8, in step S145, the operation display unit of a user terminal 3 displays the answering entity candidates received from the server 2. When the user selects a preferred answering entity (S148), the operation display unit recognizes the user's selection operation, and notifies the request analysis unit of information about the selection of an answering entity. Here, an example of a screen displaying the answering entity candidates is shown in FIG. 9. Note that, in FIG. 9, as an example, a display screen example which is displayed on a touch panel display when the user terminal 3 is implemented as a smartphone, tablet terminal, or the like, will be described.

FIG. 9 is a diagram showing an example of a screen displaying answering entity candidates. In FIG. 9, a display screen 40 displays four answering entity candidates 400, 410, 420, and 430. Also, when an answer which is to be paid for by points is available, the display screen 40 also includes a display 406 indicating the number of points which are currently possessed by the user.

Specifically, a mail icon 401 for indicating whether or not detailed information has been viewed indicates that detailed information about the answering entity candidate 400 on the first row has not been viewed. A display 402 for indicating a price (in points) required when an answer is received (information is provided) indicates that no fee is charged. Also, a display 403 for indicating the way to answer indicates that a text-based answer is provided. A display 404 for indicating an overview of information indicates that the information is about “recommended ramen restaurants.” A display 405 for indicating the class of an answering entity indicates that the answering entity is a specialist.

Next, in step S154, the request analysis unit of the user terminal 3 rates the user profile. Specifically, the user has selected an answering entity candidate, and therefore, it is found that the above produced request context (see FIG. 4, the assumed request 30) is correct, so that the user profile tree (virtual personality user model) constructed as the user profile is rated more highly or the like.

Next, in step S157, the user terminal 3 transmits the answering entity selection (information about the selection of an answering entity candidate by the user) to the server 2.

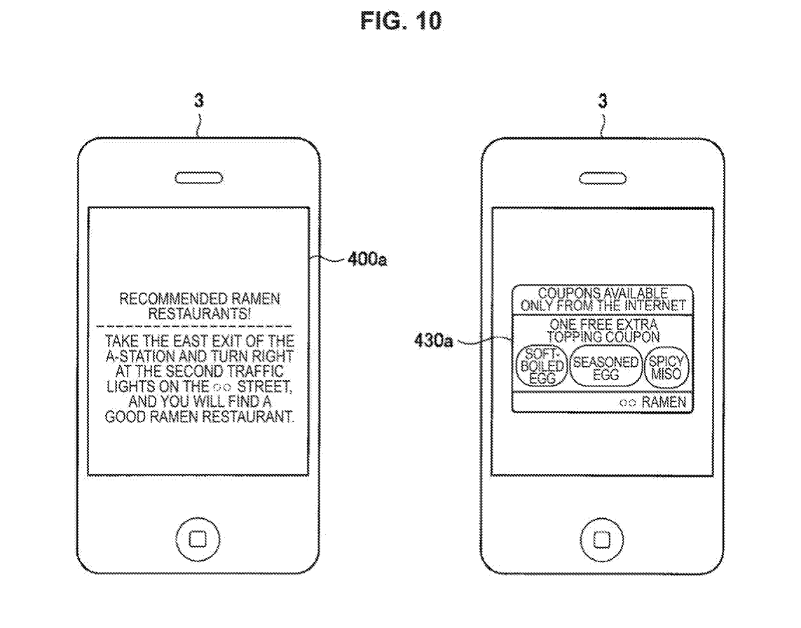

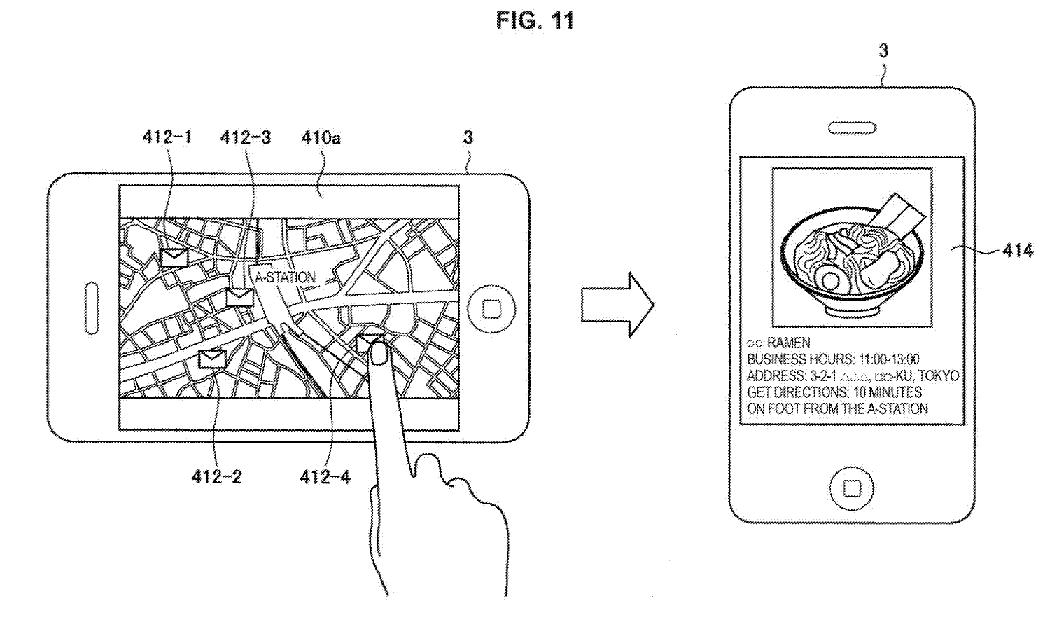

Next, in step S160, when the result is instantaneous, such as text or the like, the answering process unit 20d of the server 2 transmits the result (answer information) to the user terminal 3, and the operation display unit of the user terminal 3 presents the result to the user. Here, a display example of an instantaneous result, such as text or the like (answer information), will be described with reference to FIG. 10 and FIG. 11.

FIG. 10 is a diagram showing a display example of a result in a case where an answer is provided in a text-based manner. An answer screen 400a shown in a left portion of FIG. 10 is a text-based answer example which is displayed when the answering entity candidate 400 shown in FIG. 9 is selected, for example. Also, an answer screen 430a shown in a right portion of FIG. 10 is a text-based answer example which is displayed when the answering entity candidate 430 shown in FIG. 9 is selected, for example.

FIG. 11 is a diagram showing a display example of a result in a case where an answer is provided in a map-based manner. An answer screen 410a shown in a left portion of FIG. 11 is a map-based answer example which is displayed when the answering entity candidate 410 shown in FIG. 9 is selected, for example. In the answer screen 410a, a plurality of pieces of information about recommended lunch near the A-station are mapped on a map using mail icons 412-1 to 412-4. The mapping corresponds to the location of each restaurant to be introduced. Therefore, the user can select a restaurant after understanding some features of the restaurant. For example, the user can select a restaurant close to their location. Specifically, for example, the user can select the mail icon 412-4 which is mapped near the exit of the A-station, where the user is currently located. When the user selects the mail icon 412-4, a detail screen 414 including detailed information about the restaurant is displayed as shown in a right portion of FIG. 11.

Meanwhile, for example, when the answering entity candidate 420 shown in FIG. 9 is selected, the way to answer is voice communication (voice navigation), and therefore, the server 2 performs a process of connecting the user to the answering entity. Specifically, the answering process unit 20d of the server 2 performs a process of connecting to the answering entity with respect to the user terminal 3 in step S163, and a process of connecting to the user terminal 3 with respect to the answering entity terminal in step S166.

As a result, in step S169, voice communication (or videotelephony communication, etc.) is performed between the user terminal 3 and the answering entity terminal so that the user's question can be responded in real time.

### 3-3. Feedback Process

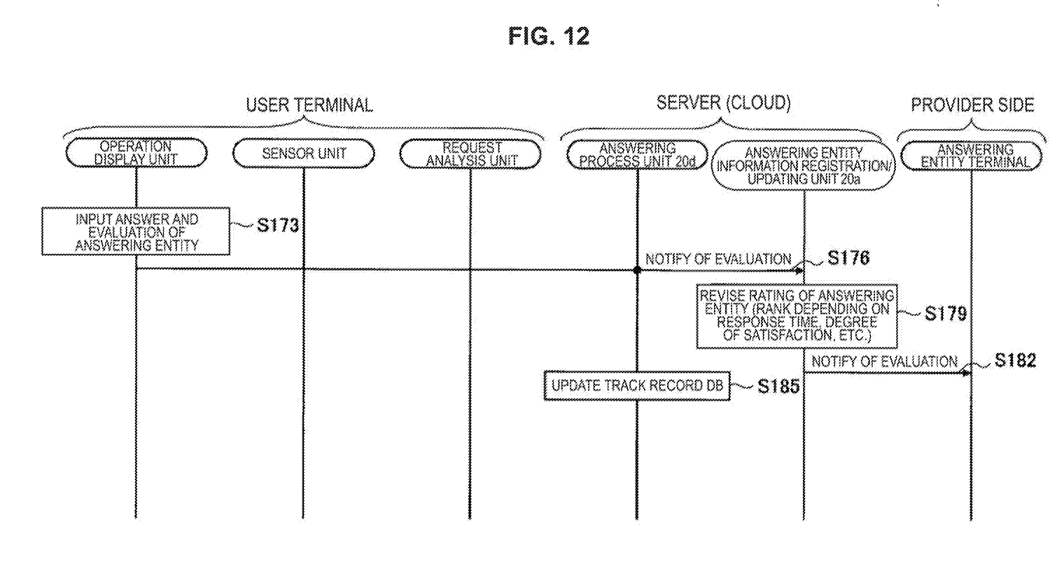

Next, feedback on an answering entity after a user obtains an answer will be described with reference to FIG. 12. FIG. 12 is a sequence diagram of a feedback process according to this embodiment. As shown in FIG. 12, initially, in step S173, a user terminal 3 recognizes an answer or an evaluation of an answering entity input by the user, using the operation display unit. The evaluation by the user includes, for example, a polite answer, a quick answer, a detailed answer, and the like. Also, the evaluation of an answer by the user includes, for example, the degree of satisfaction, a rank, and the like.

Next, in step S176, the user terminal 3 notifies the server 2 of information about the recognized evaluation.

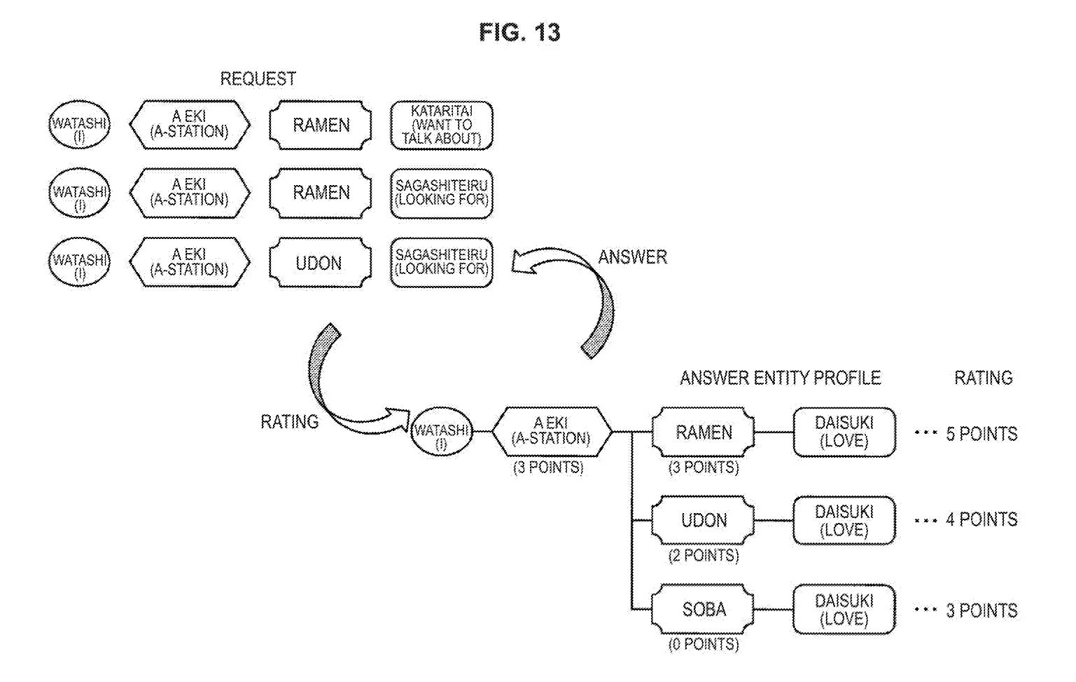

Next, in step S179, the answering entity information registration/updating unit 20a of the server 2 revises the rating (e.g., a “rate” included in the answer history DB 24 shown in FIG. 7) of an answering entity included in an answering entity profile stored in the answering entity DB 26 on the basis of the received information about the evaluation by the user. The rating may be determined on the basis of a rank corresponding to, for example, the response time, the degree of satisfaction, or the like, or the number of points (e.g., a point addition scheme). Here, an example of revision of the rating of an answering entity profile is shown in FIG. 13.

In the example shown in FIG. 13, points are added for each element on the basis of the answer track record. More specifically, when an answering entity having an answering entity profile shown in a lower right portion of FIG. 13 has provided answers all of which have a satisfaction degree of a predetermined value or more with respect to three requests shown in an upper left portion of FIG. 13, the rating is increased according to the factors (elements) of each request. Specifically, the number of times an element appears in requests is equal to the number of points which are added. Therefore, as shown in FIG. 13, three points are added to “A eki (A-station),” two points are added to “ramen,” one point is added to “udon,” and no point is added to “soba.” As a result, even when the answering entity profile initially indicates that the answering entity simply prefers all of ramen, udon, and soba near the A-station, the answering entity profile is updated by rating revision to indicate that the answering entity has a high level of evaluation on ramen at the A-station.

Also, in step S182, the server 2 may notify an answering entity of information about evaluation. The feeding back of information about an evaluation of an answering entity can promote an improvement in the quality of services. Also, when an answering entity is an answer engine, the feeding back of information about an evaluation can further improve the quality of the answer engine.

Also, in step S185, the answering process unit 20d may update the track record DB 22. Specifically, the answering process unit 20d registers a hashed request in the request history DB 23 included in the track record DB 22 or updates the status of a hashed request (successfully answered, etc.) stored in the request history DB 23 included in the track record DB 22.

In the foregoing, the automatic request assignment operating process according to this embodiment has been specifically described. Although, in the above embodiments, the request analysis unit (context production unit) is included in a user terminal, the present disclosure is not limited to this. The request analysis unit may be provided in a server.

### 4. APPLICATION EXAMPLES

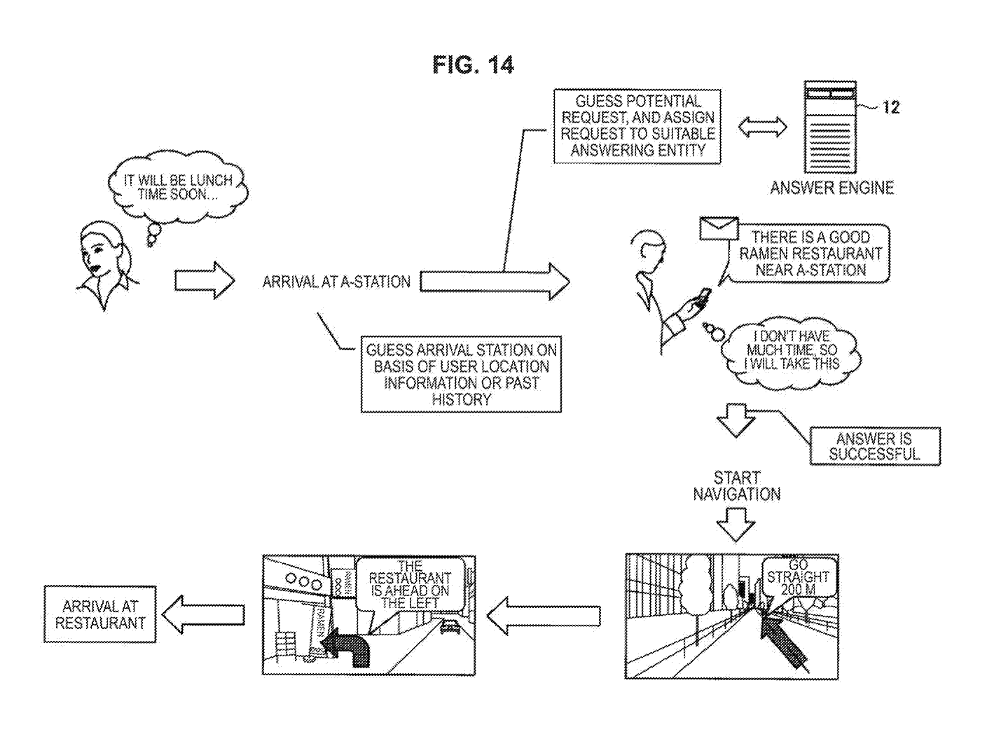

Next, a use example of the automatic request assignment system according to this embodiment will be described with reference to FIG. 14 to FIG. 16.

### 4-1. First Application Example

FIG. 14 is a diagram for describing a first application example according to this embodiment. Here, a user's potential request is guessed on the basis of sensing data, and is assigned to an answer engine (automatic order acceptance entity).

Specifically, in FIG. 14, a user's movements (changes in movements by train, car, and foot, etc.) are recognized on the basis of continual collection of the user's location information, and the station where the user has arrived is guessed on the basis of the user's past action history, and the like. In addition, a potential assumed request (request context) indicating that a user is looking for a restaurant for lunch near the station where the user has arrived is produced according to the time zone or the like.

Next, for example, the answer engine 12 is selected as a suitable answering entity according to the produced assumed request, and is displayed as an answering entity candidate.

The user views an overview of information like “There is a good ramen restaurant near the A-station!” When the user selects it, the answer (the proposal thereof) is successful, and the answer engine 12 starts navigation.

As shown in FIG. 14, the navigation may, for example, be a technique of presenting an image which is obtained by superimposing a sign indicating a movement direction or a guide sign on an image of a scenery around the location where the user is currently present. When the user is wearing a glasses-type HMD, a sign indicating a movement direction or the like superimposed on an actual spatial scenery is displayed on a transparent display unit provided at a portion corresponding to a lens unit.

Thus, in this embodiment, even when the user does not input an explicit request, a potential request may be guessed, and an answering entity candidate may be automatically presented.

### 4-2. Second Application Example

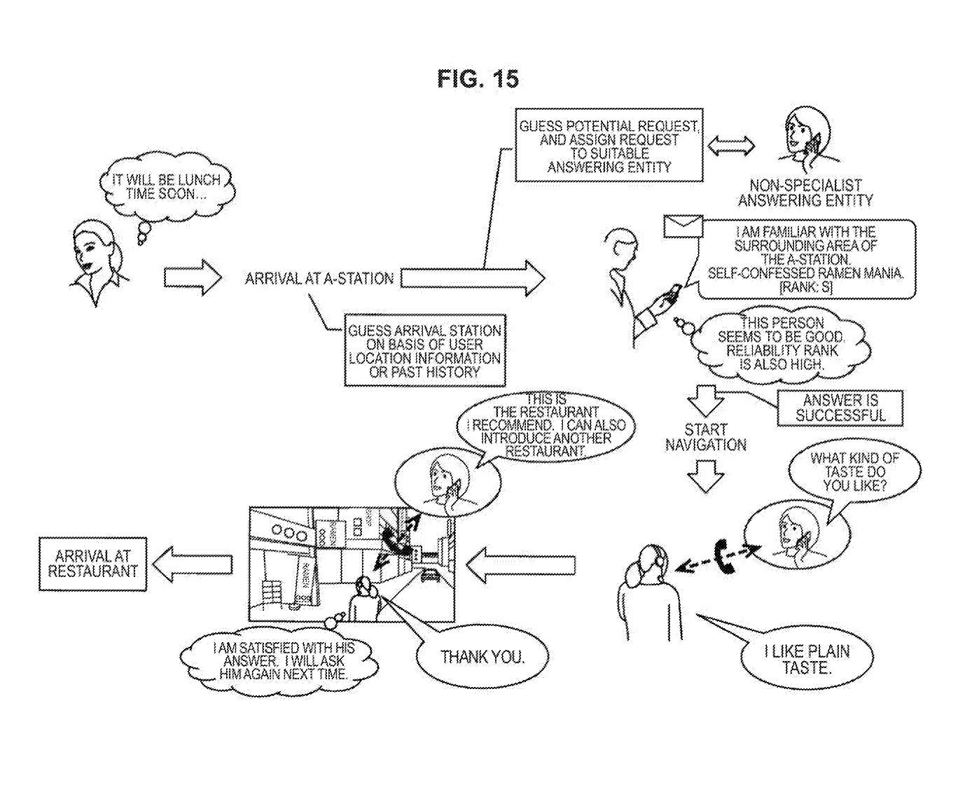

FIG. 15 is a diagram for describing a second application example according to this embodiment. Here, a user's potential request is guessed on the basis of the sensing data, and is assigned to a non-specialist answering entity (ordinary user).

Specifically, in FIG. 15, as in the first application example shown in FIG. 14, a user's potential assumed request (request context) is produced on the basis of sensing data, such as a current location or the like.

Next, for example, a non-specialist answering entity is selected as an answering entity suitable for the produced assumed request, and is presented as an answering entity candidate.

The user views a text of profile of an answering entity including an evaluation rank thereof like “I am familiar with the surrounding area of the A-station. Self-confessed ramen mania. Rank: S.” When the user selects this, the answer (the proposal thereof) is successful, and the non-specialist answering entity starts navigation.

As shown in FIG. 15, the navigation may, for example, be a technique of guiding the user by direct communication through voice communication (telephone call). The user can obtain an answer after directly telling a specific request, such as their preferred taste or the like.

Thus, in this embodiment, even when a user does not input an explicit request, a potential request may be guessed, and an answering entity candidate may be automatically presented. Also, after obtaining an answer, the user evaluates an answering entity, leading to an improvement in the quality of the answering entity.

### 4-3. Third Application Example

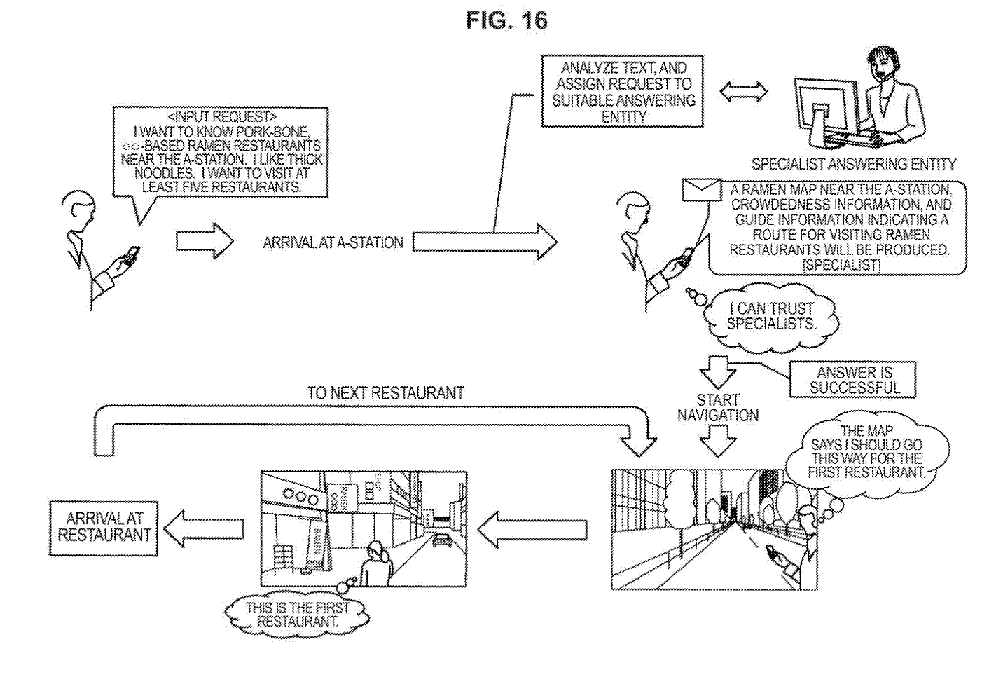

FIG. 16 is a diagram for describing a third application example according to this embodiment. Here, a user's manifest request is guessed on the basis of an explicitly input request, and is assigned to a specialist answering entity (specialist).

Specifically, in FIG. 16, a user explicitly inputs a request. The input request is analyzed to produce a manifest request context.

Next, for example, a specialist answering entity is selected as an answering entity suitable for the produced request context, and is presented as an answering entity candidate to the user.

The user views an overview of information like “A ramen map near the A-station, crowdedness information, and guide information indicating a route for visiting ramen restaurants will be produced. Specialist,” and the class of the answering entity (the answering entity is a specialist). When the user selects the answering entity, the answer (the proposal thereof) is successful, and the specialist starts navigation.

The navigation may, for example, be a technique of providing a map-based presentation. The user successively visits ramen restaurants, following a route indicated on a map displayed on the screen of the user terminal.

Thus, in this embodiment, when a user inputs an explicit request, the server 2 can determine the difficulty of the request and present a suitable answering entity candidate to the user, such as assignment to a specialist if the content of the request is complicated, or the like.

### 5. CONCLUSION

As described above, the automatic request assignment system according to an embodiment of the present disclosure can present an answering entity candidate to a user for the purpose of optimum assignment of a request.

As a result, different services having different advantages can be more effectively utilized. Also, the quality of services can be further improved by performing evaluation feedback.

Also, in this embodiment, question requests having a high collective intelligence rate (questions which are raised by a number of people and can be answered by a number of people) are likely to be already accumulated in the track record DB 22, and can be quickly responded by searching the track record DB 22.

Also, when a request has an ambiguous context, then if the context is complicated, the request is assigned to a service supported by a human being such as a specialist, non-specialist, or the like, or then if the context is simple, the request is assigned to an apparatus such as an answer engine or the like. Therefore, relatively broad context interpretation can be performed compared to existing answering services.

Also, requests are screened for assignment to a specialist, and therefore, labor costs in the entire system can be optimized.

Also, a complicated context which can be understood only by human beings is assigned to a human being (a specialist, a non-specialist) when it is the first time that the request is answered. Request/answer records are accumulated into the track record DB 22. The request can be automatically answered immediately the next time round. Thus, more and more contexts can be immediately answered.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, computer programs for providing the functions of the server 2 and a user terminal 3 can be produced in hardware, such as a CPU, ROM, RAM, or the like included in the server 2 and the user terminal 3. Also, computer readable storage media storing the computer programs are provided.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1)

An information processing apparatus including:

a selection unit configured to check each element included in a context of a user request against an answering entity profile, and select an answering entity candidate capable of answering the context of the user request; and

a presentation unit configured to present the answering entity candidate selected by the selection unit to a user who has issued the request.

(2)

The information processing apparatus according to (1),

wherein the selection unit selects a plurality of answering entity candidates, and

the presentation unit presents the plurality of answering entity candidates to the user.

(3)

The information processing apparatus according to (2), further including:

an answering process unit configured to transmit the context of the user request to an answering entity candidate selected by the user from the plurality of answering entity candidates, and make an inquiry.
(4)

The information processing apparatus according to (3),

wherein the answering process unit performs a process of connecting the user and the answering entity candidate selected by the user.

(5)

The information processing apparatus according to any one of (2) to (4),

wherein the presentation unit controls a user terminal in a manner that the user terminal displays a display screen indicating information about the plurality of answering entity candidates.

(6)

The information processing apparatus according to (5),

wherein the information about the answering entity candidates includes an overview of answer information, a type of a way to answer, and a class of an answering entity.

(7)

The information processing apparatus according to any one of (1) to (6), further including:

a context production unit configured to produce the context of the user request on the basis of a user condition.

(8)

The information processing apparatus according to (7),

wherein the context production unit analyzes an explicit request input by the user to produce the context.

(9)

The information processing apparatus according to any one of (1) to (8), further including:

a track record search unit configured to search a track record database for an answer on the basis of the context of the user request,

wherein the presentation unit additionally presents the searched answer to the user.

(10)

The information processing apparatus according to any one of (1) to (9), further including:

an updating unit configured to update a database of the answering entity profile on the basis of evaluation of an answer by the user.

(11)

A control method including:

checking each element included in a context of a user request against an answering entity profile, and selecting an answering entity candidate capable of answering the context of the user request; and

presenting the selected answering entity candidate to a user who has issued the request.

(12)

A program for causing a computer to function as:

a selection unit configured to check each element included in a context of a user request against an answering entity profile, and select an answering entity candidate capable of answering the context of the user request; and

a presentation unit configured to present the answering entity candidate selected by the selection unit to a user who has issued the request.

### REFERENCE SIGNS LIST

2 server
20 control unit
20a answering entity information registration/updating unit
20b track record search unit
20c answering entity selection unit
20d answering process unit
21 communication unit
22 track record DB
23 request history DB
24 answer history DB
26 answering entity DB
3 (3a, 3b, 3c) user terminal
10, 11 answering entity terminal
12 answer engine

1. An information processing apparatus comprising:
a selection unit configured to check each element included in a context of a user request against an answering entity profile, and select an answering entity candidate capable of answering the context of the user request; and
a presentation unit configured to present the answering entity candidate selected by the selection unit to a user who has issued the request.

2. The information processing apparatus according to claim 1,
wherein the selection unit selects a plurality of answering entity candidates, and
the presentation unit presents the plurality of answering entity candidates to the user.

3. The information processing apparatus according to claim 2, further comprising:
an answering process unit configured to transmit the context of the user request to an answering entity candidate selected by the user from the plurality of answering entity candidates, and make an inquiry.

4. The information processing apparatus according to claim 3,
wherein the answering process unit performs a process of connecting the user and the answering entity candidate selected by the user.

5. The information processing apparatus according to claim 2,
wherein the presentation unit controls a user terminal in a manner that the user terminal displays a display screen indicating information about the plurality of answering entity candidates.

6. The information processing apparatus according to claim 5,
wherein the information about the answering entity candidates includes an overview of answer information, a type of a way to answer, and a class of an answering entity.

7. The information processing apparatus according to claim 1, further comprising:
a context production unit configured to produce the context of the user request on the basis of a user condition.

8. The information processing apparatus according to claim 7,
wherein the context production unit analyzes an explicit request input by the user to produce the context.

9. The information processing apparatus according to claim 1, further comprising:
a track record search unit configured to search a track record database for an answer on the basis of the context of the user request,
wherein the presentation unit additionally presents the searched answer to the user.

10. The information processing apparatus according to claim 1, further comprising:
an updating unit configured to update a database of the answering entity profile on the basis of evaluation of an answer by the user.

11. A control method comprising:
checking each element included in a context of a user request against an answering entity profile, and selecting an answering entity candidate capable of answering the context of the user request; and
presenting the selected answering entity candidate to a user who has issued the request.

12. A program for causing a computer to function as:
a selection unit configured to check each element included in a context of a user request against an answering entity profile, and select an answering entity candidate capable of answering the context of the user request; and
a presentation unit configured to present the answering entity candidate selected by the selection unit to a user who has issued the request.
